(19) United States
(12) Patent Application Publication
(10) Pub. No.: US 2005/0069616 A1
(43) Pub. Date: Mar. 31, 2005

(54) Naturally-sweetened reduced-calorie beverages

(75) Inventors: Thomas D. Lee, Scarsdale, NY (US); Zena Bell, Hartsdale, NY (US)

Correspondence Address: FITZPATRICK CELLA HARPER & SCINTO, 30 ROCKEFELLER PLAZA, NEW YORK, NY, 10112, US

(73) Assignee: PEPSICO, INC., PURCHASE, NY (US)

(21) Appl. No.: 10/897,677

(22) Filed: Jul. 23, 2004

Related U.S. Application Data
(60) Provisional application No. 60/489,677, filed on Jul. 24, 2003.

(51) Int. Cl. A23L 1/236

(52) U.S. Cl. 426/548

(57) ABSTRACT

A combination of HFCS-90 and at least one low-calorie natural sweetener is used to reduce the caloric content of a full-calorie beverage while preserving the taste.

This application claims the benefit of U.S. Provisional Application No. 60/489,677, filed Jul. 24, 2003.

### BACKGROUND OF THE INVENTION

1. Field of the Invention

This invention relates to naturally-sweetened reduced-calorie beverages. More particularly, this invention relates to beverages sweetened with a combination of HFCS-90 (high fructose corn syrup-90) and at least one low-calorie natural sweetener, as well as to methods of making the same.

2. Related Background Art

Zero- or low-calorie beverages are very popular. Such diet products typically contain, singularly or in blends, non-nutritive sweeteners such as aspartame, acesulfame-K, saccharin, sucralose and cyclamate. While consumers do not have to worry about calories with such diet products, some consumers would prefer not to consume high intensity artificial sweeteners. However, because there are no naturally occurring, intense sweeteners approved for use in the United States, it is difficult to formulate good tasting, naturally sweetened reduced-calorie beverages.

Heretofore, partial substitution of a nutritive sweetener with a low-calorie natural sweetener produced reduced-calorie products lacking in certain respects as compared with naturally sweetened, full-calorie counterparts. Such products may not be sweet enough, may have off-tastes or may have incompatibilities with certain flavors. Hence, there is a need for good quality, naturally sweetened, reduced-calorie beverages.

High fructose corn syrup (HFCS) is made by isomerization of glucose to fructose in corn syrup. Corn refiners such as Cargill, ADM, and Staley routinely make HFCS-42 (lowest grade; Brix 71, i.e., 71% solid with 29% water; 42% fructose and 58% glucose and higher polymers of glucose in the solids portion) and HFCS-90 (highest grade; Brix 77; 90% fructose and 10% glucose and higher polymers of glucose in the solids portion). HFCS-42 is the cheapest grade of HFCS and is, therefore, widely used; it has about the same sweetness as sugar. Large beverage companies tend to use HFCS-55 (medium grade; Brix 77; 55% fructose and 45% glucose and higher polymers of glucose in the solids portion), which is made by blending HFCS-42 and HFCS-90; though HFCS-55 is slightly more expensive than HFCS-42, it is also sweeter.

Due primarily to cost considerations, HFCS-90 is not typically employed as a sweetening agent in beverages. Rather, HFCS-90 is produced mainly for purposes of blending with HFCS-42 to make HFCS-55. The use of HFCS-90 in achieving naturally-sweetened reduced-calorie beverages has not heretofore been described.

### SUMMARY OF THE INVENTION

This invention is directed to a reduced-calorie beverage sweetened with HFCS-90 and at least one low-calorie natural sweetener. In certain preferred embodiments, the at least one low-calorie natural sweetener is selected from D-tagatose, erythritol, sorbitol, mannitol, lactitol, maltitol and xylitol.

In preferred embodiments of the present invention, a caloric reduction ranging from about 25% to about 60%, more preferably ranging from about 30% to about 40%, is achieved. Such a reduction is as compared to the caloric content of a full-calorie counterpart beverage. In preferred embodiments of the present invention, the at least one low-calorie natural sweetener is employed in an amount ranging from about 0.2% to about 3.5% based on finished beverage weight.

The reduced-calorie beverages of the present invention can be selected from soft drinks, fountain beverages, frozen ready-to-drink beverages, coffee beverages, tea beverages, dairy beverages, powdered soft drinks, liquid concentrates, flavored waters, enhanced waters, fruit juice and fruit juice flavored drinks, sport drinks and alcoholic drinks.

The present invention is further directed to a method of making a reduced-calorie beverage which comprises including in a beverage HFCS-90 and at least one low-calorie natural sweetener.

The invention is also directed to a sweetener composition consisting essentially of HFCS-90 and at least one low-calorie natural sweetener.

### DETAILED DESCRIPTION

A combination of HFCS-90 (high fructose corn syrup-90) and at least one low-calorie natural sweetener is used to sweeten beverage formulations to achieve reduced-calorie beverages which have substantially the same sweetness and taste associated with full-calorie counterpart beverages. In preferred embodiments of this invention, a reduction of calories ranging from about 25% to about 60%, more preferably ranging from about 30% to about 40%, is achieved.

As used herein, “taste” refers to a combination of sweetness perception, temporal effects of sweetness perception, i.e., on-set and duration, off-tastes, e.g., bitterness and metallic taste, residual perception (aftertaste) and tactile perception, e.g., body and thickness. As used herein, “reduced calorie” means having a reduced number of calories as compared with a full-calorie counterpart; more particularly, “reduced calorie” typically means having at least a 25% reduction in calories per serving, e.g., per 8 oz. for beverages. As used herein, “low-calorie natural sweetener” refers to a naturally-occurring material which imparts sweetness to a beverage and which has a caloric content of less than 4 cal/g. As used herein, “full-calorie” refers to a composition which is sweetened with a nutritive sweetener such as HFCS-55, HFCS-42, sucrose, etc.

Beverages include, without limitation, carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice flavored drinks, sport drinks and alcoholic products. The beverage may be carbonated or noncarbonated. In a preferred embodiment of the present invention, the beverage is a flavored water, an enhanced water, or a carbonated cola-flavored soft drink.

According to the first embodiment of the present invention, a reduced-calorie beverage comprises (a) HFCS-90 and (b) at least one low-calorie natural sweetener. In other words, the reduced-calorie beverage of the present invention can be, and preferably is only, sweetened by HFCS-90 and at least one low-calorie natural sweetener.

HFCS-90 suitable for use in the present invention is well-known and commercially available through a variety of corn refiners (e.g., Cargill, Wayzata, Minn.; ADM, Decatur, Ill.). As noted above, HFCS-90 is a high fructose corn syrup that has a Brix of about 77, i.e., 77% solid, and that has a ratio of fructose to other saccharides such as glucose of about 90 to 10 in the solid portion.

It is important to note that it is necessary to confirm the Brix of the HFCS-90 starting material; if the Brix is not 77, then the weight of the HFCS-90 must be adjusted for the actual solids percent. As one of ordinary skill in the art will readily appreciate, the Brix may vary from manufacturer to manufacturer, due to age, or for many other reasons. Accordingly, it is recommended to measure the Brix of the HFCS-90 starting material prior to using it for purposes of this invention; such a measurement can be made according to any known procedure such as through the use of a refractometer or density meter.

Low-calorie natural sweeteners suitable for use in the present invention include, without limitation, D-tagatose, erythritol, sorbitol, mannitol, lactitol, maltitol and xylitol. D-tagatose can be obtained from Arla Foods (Union, N.J.) and is reported to impart about 1.5 calories/g. Erythritol, i.e., meso-erythritol, can be obtained from Cargill (Wayzata, Minn.) and is reported to generate almost no calories (0.2 calorie/g). Typically, the at least one low-calorie natural sweetener is included in an amount from about 0.2% to 3.5% of the finished beverage, preferably from about 0.2% to about 1.0% for D-tagatose and from about 0.2% to about 3.5% for erythritol, of the finished beverage by weight.

One of ordinary skill in this art will readily appreciate that the overall amount of HFCS-90 and low-calorie natural sweetener(s) in a finished beverage will vary depending on a variety of factors such as the desired overall sweetness for a given application. Appropriate amounts can be readily determined by one of ordinary skill in this art. More important to the present invention is the realization of a reduced-calorie beverage having the same sweetness and taste profile as a full-calorie counterpart beverage. In preferred embodiments of this invention, the full-calorie counterpart beverage is sweetened with HFCS-55 or HFCS-42.

Accordingly, once the appropriate level of sweetness is determined for a full-calorie counterpart beverage, it is then possible to calculate its caloric content. From there, the amounts of HFCS-90 and the at least one low-calorie natural sweetener, for purposes of the present invention, can be readily determined by setting a “calorie target” which ranges from about 25% to about 60%, more preferably from about 30% to about 40%, of the caloric content of the full-calorie counterpart beverage. As one of ordinary skill in this art will readily appreciate, when incorporating amounts of the at least one low-calorie natural sweetener as set forth above, the caloric contribution of erythritol will be negligible, while the caloric contribution of D-tagatose is small though non-negligible. An amount of HFCS-90 suitable for use in the present invention can be readily determined using the above guidelines.

It is possible to include any other ingredients typically used in beverages in appropriate amounts in the reduced-calorie beverages of the present invention. One of ordinary skill in the art would be capable of determining appropriate usage levels. Such ingredients include, without limitation, flavors, colors, preservatives, acidulants, buffering salts, caffeine, anti-foam agents and foaming agents. Furthermore, if a higher degree of sweetness is desired, it is possible to include natural high potency sweeteners such as stevia, lo han guo, monatin, thaumatin, ammonium glycyrrhyzin and combinations thereof without departing from the spirit of this invention.

A second embodiment of the present invention is directed to a method of making a reduced-calorie beverage which comprises sweetening a beverage with a combination of (a) HFCS-90 and (b) at least one low-calorie natural sweetener. Additional embodiments of the invention are directed to reduced-calorie beverages made according to this method. The details regarding the amount of HFCS-90 and low-calorie natural sweetener(s) are as above detailed with respect to the first embodiment of this invention.

A final embodiment of the present invention is directed to a sweetener composition consisting essentially of (a) HFCS-90 and (b) at least one low-calorie natural sweetener as set forth above. Of course, this sweetener can be used to make reduced-calorie beverages having the same sweetness and taste profile as full-calorie counterpart beverages.

The examples which follow are intended as an illustration of certain preferred embodiments of the invention, and no limitation of the invention is implied.

### EXAMPLE 1

A 2-liter syrup for use in making a reduced-calorie cola carbonated soft drink was prepared. More particularly, the amount of HFCS-90 was determined by calculating the amount necessary to achieve a caloric reduction of about 25% as compared to a full-calorie beverage sweetened with HFCS-55. The ingredients listed in Table 1 were combined as follows:

TABLE 1

| ingredient | (g) |
|---|---|
| HFCS-90 | 1250 |
| D-tagatose | 90 |
| potassium citrate | 3 |
| sodium benzoate | 2.046 |
| acidulant and flavors | 36.08 |
| purified water | Q. S. 2 L |

HFCS-90 and tagatose were dissolved in about 0.5 L water with vigorous stirring. To the sweetener solution, a water solution of citrate and benzoate was added. This was followed by acidulant and flavors, and the volume of the syrup was adjusted to 2 L by adding water. The syrup thus made was mixed with carbonated water in a one part syrup with 5 parts carbonated water to become finished reduced-calorie cola drink. The finished reduced-calorie, naturally sweetened cola drink was judged by a trained panel to have the same sweetness and taste as a full-calorie counterpart.

### COMPARATIVE EXAMPLE 1

A 2-liter syrup for use in making a reduced-calorie cola carbonated soft drink is prepared. More particularly, the amount of HFCS-55 is determined by calculating the amount necessary to achieve a caloric reduction of about 25% as compared to a full-calorie beverage sweetened with HFCS-55. The ingredients listed in Table 2 are combined as follows:

TABLE 2

| ingredient | (g) |
|---|---|
| HFCS-55 | 1250 |
| D-tagatose | 90 |
| potassium citrate | 3 |
| sodium benzoate | 2.046 |
| acidulant and flavors | 36.08 |
| purified water | Q. S. 2 L |

HFCS-55 and tagatose are dissolved in about 0.5 L water with vigorous stirring. To the sweetener solution, a water solution of citrate and benzoate is added. This is followed by acidulant and flavors, and the volume of the syrup is adjusted to 2 L by adding water. The syrup thus made is mixed with carbonated water in a one part syrup with 5 parts carbonated water to become finished reduced-calorie cola drink. The finished reduced-calorie, naturally sweetened cola drink is judged by a trained panel to have an unacceptable level of sweetness as compared to a full-calorie counterpart.

Other variations and modifications of this invention will be obvious to those skilled in this art. This invention is not to be limited except as set forth in the following claims.

1. A reduced-calorie beverage comprising (a) HFCS-90 and (b) at least one low-calorie natural sweetener.

2. The reduced-calorie beverage according to claim 1, wherein the at least one low-calorie natural sweetener is selected from the group consisting of D-tagatose, erythritol, sorbitol, mannitol, lactitol, maltitol and xylitol.

3. The reduced-calorie beverage according to claim 1, wherein the at least one low-calorie natural sweetener is present in an amount of about 0.2% to about 3.5% based on finished reduced-calorie beverage weight.

4. The reduced-calorie beverage according to claim 1, wherein said beverage is selected from the group consisting of soft drinks, fountain beverages, frozen ready-to-drink beverages, coffee beverages, tea beverages, dairy beverages, powdered soft drinks, liquid concentrates, flavored waters, enhanced waters, fruit juice and fruit juice flavored drinks, sport drinks and alcoholic drinks.

5. The reduced-calorie beverage according to claim 1, wherein a reduction in calories ranging from about 25% to about 60% as compared to a full-calorie counterpart beverage is achieved.

6. A method of making a reduced-calorie beverage including the step of sweetening said reduced-calorie beverage with (a) HFCS-90 and (b) at least one low-calorie natural sweetener.

7. The method according to claim 6, wherein the at least one low-calorie natural sweetener is selected from the group consisting of D-tagatose, erythritol, sorbitol, mannitol, lactitol, maltitol and xylitol.

8. The method according to claim 6, wherein the at least one low-calorie natural sweetener is present in an amount of about 0.2% to about 3.5% based on finished reduced-calorie beverage weight.

9. The method according to claim 6, wherein said beverage is selected from the group consisting of soft drinks, fountain beverages, frozen ready-to-drink beverages, coffee beverages, tea beverages, dairy beverages, powdered soft drinks, liquid concentrates, flavored waters, enhanced waters, fruit juice and fruit juice flavored drinks, sport drinks and alcoholic drinks.

10. The method according to claim 6, wherein a reduction in calories ranging from about 25% to about 60% as compared to a full-calorie counterpart beverage is achieved.

11. A reduced-calorie beverage made according to the method of claim 6.

12. A sweetener composition consisting essentially of (a) HFCS-90 and (b) at least one low-calorie natural sweetener.
